(19) United States
(12) Patent Application Publication
(10) Pub. No.: US 2022/0191691 A1
(43) Pub. Date: Jun. 16, 2022

(54) SYSTEM AND METHOD OF PROTECTING TRANSMITTED DATA IN THE NMEA PROTOCOLS IN VEHICLE CONTROL SYSTEMS

(71) Applicant: OCEANSHIELD PTE LTD, Singapore (SG)

(72) Inventors: Dmitry Mikhaylovich MIKHAYLOV, Moscow (RU); Jonathan Erik G. SAVOIR, Singapore (SG); Mikhail Solomon ZELDOVICH, Singapore (SG)

(21) Appl. No.: 17/429,939

(22) PCT Filed: Feb. 7, 2020
(86) PCT No.: PCT/SG2020/050059

§ 371 Date: Aug. 10, 2021

(30) Foreign Application Priority Data
Feb. 12, 2019 (SG) 10201901191Y

(51) Int. Cl. H04W 12/037; H04W 4/40

(52) U.S. Cl. CPC H04W 12/037; H04W 4/40

(57) ABSTRACT

The present invention relates to a system and method for protecting transmitted data in a vehicle control system, comprising of a vehicle or navigation device and a control module communicatively connected to the navigation device according to NMEA standard; and an encryption/decryption unit integrated in the navigation device and in the control module including an AES128 block encryption algorithm in a Cipher Feedback mode (CFB mode), wherein the unit including instructions to encrypt/decrypt data transmitted between the navigation device and the control module.

### TECHNICAL FIELD

The present application relates to a method of protecting information fields of National Marine Electronics Association (NMEA) protocols, and also to options for building systems that implement this method. These NMEA protocols are used in vehicle control systems.

Recently, the number of cyberattacks has increased dramatically, including in the case of vehicles. Since the existing control systems of vehicles do not have the means of protection against information attacks of this kind, the attacker is not difficult to implement the desired. Using special technical means, an attacker can easily substitute information about the current coordinates of the vehicle, speed, direction of movement, coordinates of neighboring vehicles, etc. This information is used by the control system for subsequent decision-making in automatic or manual mode. Incorrectly transmitted data can lead to undesirable consequences such as:
Collision with another vehicle;
Collision with civilian objects;
Failure of individual subsystems or units;
Human victims;
among others.

Thus, there is an urgent need to develop a method of providing protection against cyber attacks of this kind. One option to provide this kind of protection as described in this method.

The main purpose of the method as herein described is to prevent unauthorized attacks (caused, but not limited to the substitution of transmitted data) on the vehicle control system. The implementation of the described method can be represented as a separate system or as an add-in to an existing system. The construction of the system has various options for its implementation: hardware, software or hardware.

The technology as described herein determines a method of protection of transmitted data by the NMEA protocols. Protection against unauthorized intrusion and substitution of information in the data fields of the Protocol is provided. The authentication process between devices is also provided. The implementation is an add-on to the NMEA protocols.

The NMEA protocols define the rules for the organization of data exchange between the equipment of the vehicle (mainly, but not limited to sea and rail transports). The NMEA standard is designed to provide a communication channel between the navigation equipment (time signal receiver) and the control center or control device(s).

### BRIEF DESCRIPTION OF THE DRAWINGS

FIG. 1 illustrates a typical topology of connecting devices in a serial bus standard NMEA;

FIG. 2 shows the structure of NMEA fields;

FIG. 3 illustrates a variant of man-in-the-middle attack on a serial NMEA bus;

FIG. 4 illustrates the format of NMEA messages (CGA identifier);

FIG. 5 shows the formation (preparation) of a sequence of geographic coordinates data for encryption;

FIG. 6 shows a functional block diagram of the implementation of the encryption algorithm AES128 (CFB mode) to standard NMEA;

FIG. 7 shows the distribution of the encrypted text in the fields package of standard NMEA;

FIG. 8 shows the functional implementation scheme of the block encryption algorithm AES128 (CFB mode) decryption method for the NMEA standard;

FIG. 9 shows a generalized block diagram of the system implementing the described method.

### DETAILED DESCRIPTION

The present invention deals with a method of protecting individual fields of NMEA message data containing, inter alia, information on the geographical coordinates of the vehicle (but not limited to). This data is the most important element of the information transmitted through NMEA.

According to the NMEA standard, vehicle navigation coordinates can only be transmitted in two types of messages: talker sentences and proprietary sentences.

The NMEA standard defines a large number (more than 50) of message variants for the output message type. Each of them is defined in the message ID field (202), namely through the SSS parameter (message ID). The message format for «the output message» type is shown in FIG. 2.

The geographical coordinates of the vehicle for “talker sentences” are transmitted with the following SSS message IDs (202):
[BEC] Bearing & Distance to Waypoint;
[BWR] Bearing and Distance to Waypoint;
[GGA] Global Positioning System Fix Data;
[GLL] Geographic Position;
[RMA] Recommended Minimum Navigation Information;
[RMB] Recommended Minimum Navigation Information;
[RMC] Recommended Minimum Navigation Information;
[WPL] Waypoint Location;
Among others.

Geographic coordinates of transport for some established “proprietary sentences” are transmitted with the following message identifiers:
$PGRMFPosition Fix Sentence;
$PGRMISensor Initialisation Information;
Among others.

The navigation coordinates of the vessel are determined by two parameters: latitude and longitude.

The latitude value for the “talker sentences”/“proprietary sentences” types is located in one of the dataset fields (204) in FIG. 2. For each of the SSS message IDs (202), the specified field has a set place in the general sequence of the message fields (according to the NMEA standard).

The latitude value has the following presentation format—BBBB.BBBB,a (BB—degrees; BB.BBBB—whole and fractional minutes; a—N/S).

The longitude value for the “talker sentences”/“proprietary sentences” types is in one of the dataset fields (204) FIG. 2. For each of the SSS message IDs (202), the specified field has a set place in the General sequence of message fields (according to the NMEA standard).

The longitude value has the following representation format—LLLLL.LLLL,a (LLL—degrees; LL.LLLL—whole and fractional minutes; a—E/W).

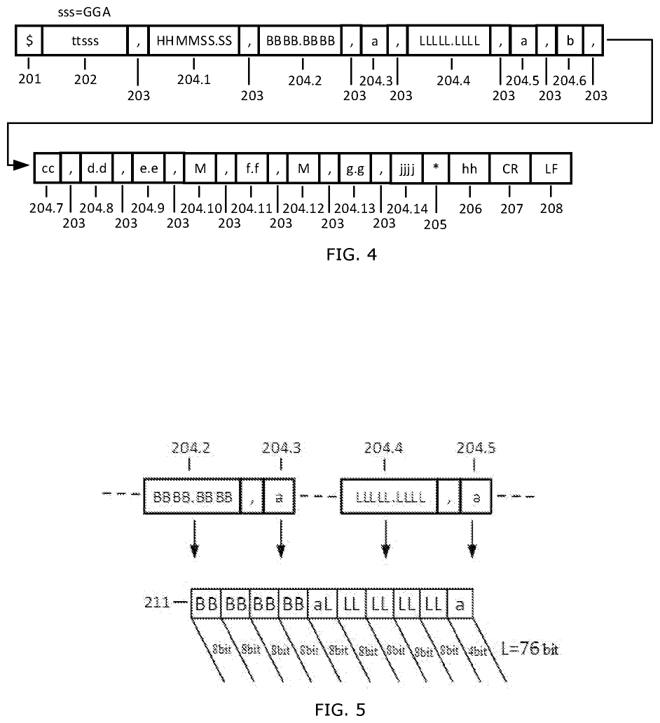

FIG. 4 shows a description of the message with the GGA type identifier (Global Positioning System Fix Data). Where data sets represented by field 204 have the following purposes: field observational time (204.1); latitude (204.2+204.3); longitude (204.4+204.5); indicator of the quality of observation (204.6); number of satellites in use, may be different from the number in view (204.7); the size of the horizontal geometric factor (204.8); the height above mean sea level (204.9); unit of height—meters (204.10); the excess of the geoid above the ellipsoid WGS-84 (204.11); unit of measurement—meters (204.12); age of differential corrections (204.13); the ID of the differential station (204.14);

The information intended for protection consists of two components: BBBB.BBBB,a +LLLLL.LLLL,a (latitude+longitude).

As a way to protect these data, it is proposed to use the AES block encryption algorithm with the encryption key length 128 (AES128). However, to use this encryption method, the following conditions must be met—the length of each block must be equal to the length of the encryption key (key), namely 128 bits.

FIG. 5 shows a method of forming the resulting sequence data (211), designed to encrypt. Data sets 204.2, 204.3, 204.4, 204.5 are the initial information for drawing up this sequence of data. The total length of the sequence 211 is 76 bits.

There are several ways to solve the problem of different length of the cipher key (128 bit) and the message block (76 bit) when using a block encryption algorithm. In the proposed method, the variant of using AES128 in the CFB mode is considered (Cipher Feedback mode).

To use the AES128 encryption algorithm, all devices must have the same cipher key. Therefore, this information must be communicated to the devices before they can start working. Methods and channels of transmission of the cipher key can be different and determined by organizational activities.

For CFB mode, you must additionally use the Initialization Vector (IV) parameter. This parameter, as well as the encrypted key, must be identical on all devices.

In the proposed method, parameter IV is used as a device authentication factor. The same IV can be used on a permanent basis or at each new communication session. Methods can be different and are determined by organizational activities.

Based on the above measures, the NMEA Protocol provides:
protection (encryption) of data fields; and
authentication of devices within the NMEA Protocol.

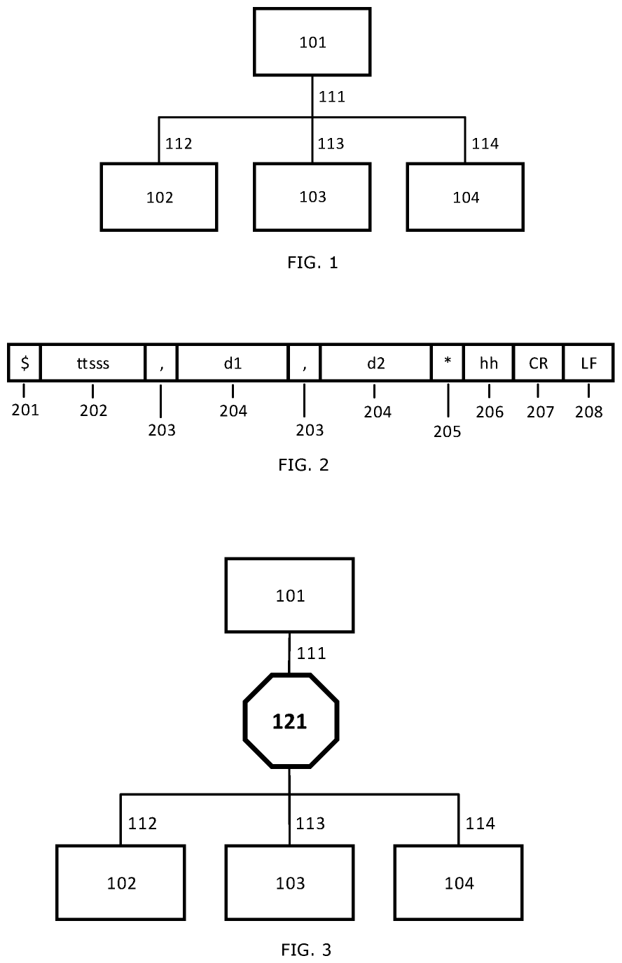

FIG. 1 shows a typical topology of connecting devices to each other according to the NMEA standard. A navigation device (101), an accurate time signal receiver can be any device that supports the NMEA standard in terms of message transmission, as well as defined to work in one or more satellite navigation systems (GPS, GLONASS, DORIS, BeiDou, Galileo & etc.). The control modules (102, 103, 104), which receive information from the device of the receiver of accurate time signals can be any device or system, for example: navigation equipment, satellite antennas, lidars, radars, radar stations, automated systems of boat traffic, etc.). A specialist in this field of technology should understand that different devices or centers can be used as modules. The number of such devices is determined by the topology of the system and the technical characteristics of the communication interface. Communication lines (111, 112, 113, 114) with which the switching of all devices involved in the exchange of data according to the NMEA standard is performed.

An asynchronous serial interface RS-422/485 or CAN interface is used as a communication interface to combine the device of the time signal receiver or navigation device (101) and control modules (102, 103, 104).

The NMEA protocols describe the format of transmitted messages, as well as the speed of exchange. For different standards (NMEA-0183, NMEA-2000), these parameters have different values, which are written directly in the standards.

The NMEA standard is a text Protocol (ASCII format). Messages can be of three types:
Talker sentences;
Query sentences;
Proprietary sentences.

FIG. 2 shows the generalized structure of the output message fields. Messages begin with “$” (201) and end with “*” (205). The message is identified by the header (202), where tt is the navigation system ID; sss is the message ID. Further, depending on the message identifier, a set of data (204) is transmitted, the number of which depends on the type. All data fields are separated by “,” (203). The “hh” (206) is the result of an 8-bit operation XOR-sum of all characters (including “,”) in the string between “$” and “*” reduced to two uppercase ASCII characters for the 16-bit representation of the byte (0-9,A-F). The “CR” (207) carriage return and “LR” (208) carriage transfer fields are an indication of the end of the message transfer.

In modern vehicles, especially in shipping and rail transport, the NMEA (serial data transmission) standard is widely used for the transmission of control and control data by ship (including geographical coordinates). These serial networks are often “connected” at several points to higher-level vessel control networks, including GPS, satellite terminal, ECDIS, etc.

These serial networks (based on NMEA) are used not only to transmit geographical coordinates, but also to monitor the operation of individual parts, such as steering gears, engines, ballast pumps, etc.

In particular, due to the fact that the publication of the first versions of the NMEA standard took place in the 90-ies of XX century, this standard is not fully able to ensure the security of the transmitted data.

However, subsequent versions of the standard (including the new generation of the NMEA-2000 standard) did not solve the above problems. The main drawbacks of the NMEA standard are that all messages do not have authentication, encryption, or validation. All data is transmitted in text format as ASCII characters. This allows an attacker to change data without hindrance when connecting to a serial network (for example, by means of «a man-in-the-middle» attack). For example, using GPS-spoofing can “embed” subtle errors to slowly but surely knock the ship off course or another vehicle. Incorrect information about the position of transport can cause consequences such as:
Crash of the transport;
Collision with other vehicles;
Infrastructure damage;
Human victims.

By attacking, intruders change information about the position and speed of transport (but not limited to the substitution of these data)—that is, the data that the control system collects and transmits, for example, the port Manager, to avoid a collision with other ships. An attack on the GPS signal or connection to the control system is fraught with navigation problems up to the collision of vehicles, which always leads to serious damage, and sometimes to human victims.

The cause of these attacks is a software vulnerability of the NMEA standard. A set of measures to protect, inform, and eliminate such attacks refers to the information security of vehicles (primarily, but not limited to modern ships, railway transport).

FIG. 3 shows one possible attack (man-in-the-middle) on a serial NMEA data bus. We considered the case when the attacker has performed the connection to your device (121). Thus, it may, at its discretion, change the data fields of the NMEA standard in messages sent by the navigation device (101). And while remaining unnoticed for the other modules (102, 103, 104).

There are several ways to protect against the presented variants of attacks: protection at the software level; and/or hardware protection.

The method presented in the present invention is designed to provide protection based on encryption/decryption of data fields of the NMEA standard, without changing the structure and sequence of fields.

### Detailed Description of the Preferred Embodiments

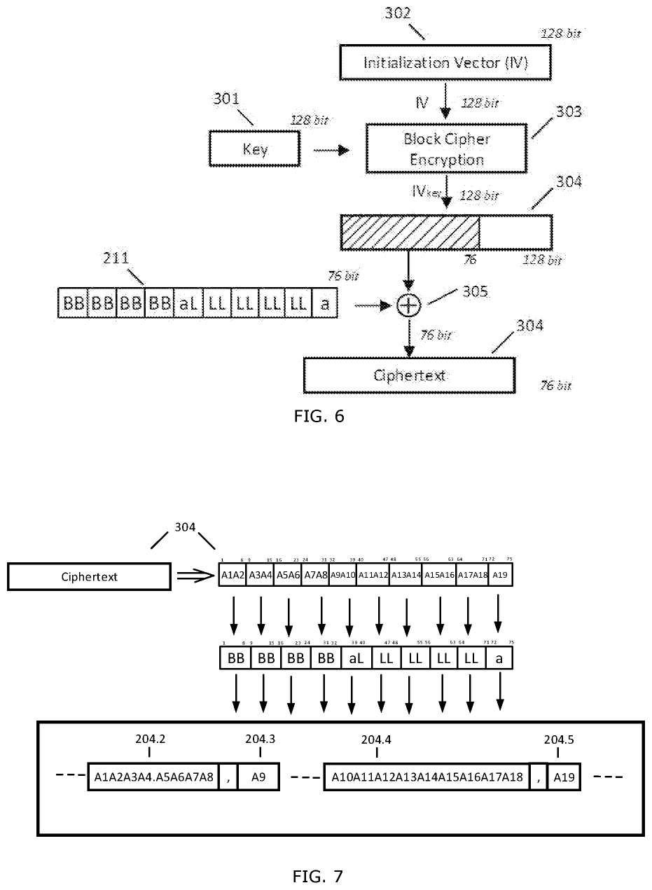

FIG. 6 shows a functional diagram of a block encryption algorithm AES128 mode (CFB) cipher text length is 76 bits. The encryption key (301) is 128 bits long, as is the Initialization Vector (302). At the beginning of the algorithm, Initialization Vector (302) is encrypted using the AES128 block encryption algorithm. Encryption takes place in Block Cipher Encryption (303) using the encryption key (301). The result of encryption is a sequence of 128 bits (304). Then the first 76 bits of information are extracted from the obtained sequence and the addition operation is performed modulo two XOR (305). The input data for the addition operation modulo two, in addition to the previously obtained sequence, is the desired prepared field (211). The result of the operation (305) is encrypted text (304), its length is 76 bits.

After receiving the encrypted text, the NMEA message packet is generated.

FIG. 7 shows the distribution of the ciphertext in the fields of the packet messages of the standard NMEA (for example, CGA). The resulting encrypted text (304) has a length of 76 bits, which corresponds to the number of ASCII characters equal to 19 (4 bits per character). In FIG. 7, every 4 bits of information is numbered A1 . . . A19. As previously shown in FIG. 5, numbered A1 . . . A19 in strict compliance are encapsulated in the package of messages of the standard NMEA.

The generated final parcel is sent to the communication channel. Becomes available to receivers. After receiving this parcel on the receiver side, the reverse process of de-encapsulation and decryption is performed.

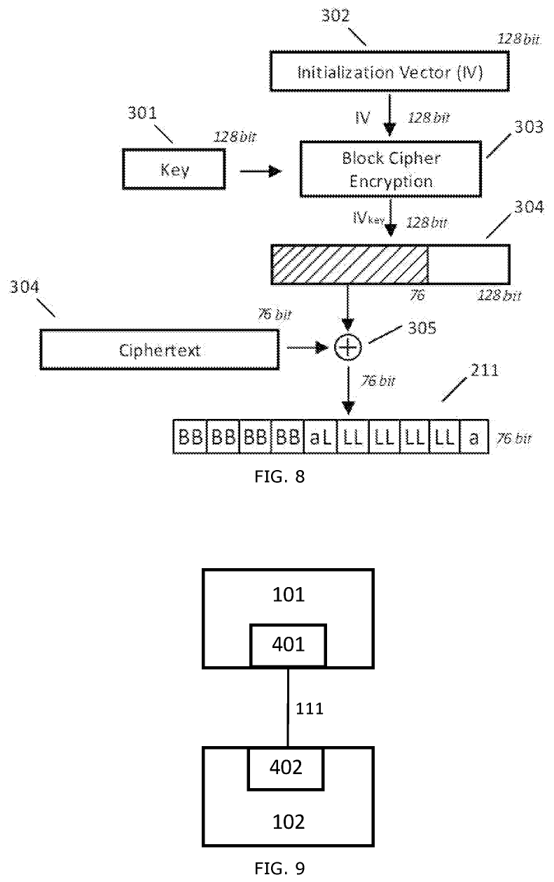

FIG. 8 shows a functional diagram block of the algorithm AES-128 (CFB mode) to decrypt a message length equal to 76 bits. The encryption key (301) is 128 bits long, as is the Initialization Vector (302). At the beginning of the algorithm, Initialization Vector (302) is encrypted using the AES128 algorithm. Encryption takes place in Block Cipher Encryption (303) using the encryption key (301). The result of encryption is a sequence of 128 bits (304). Then the first 76 bits of information are extracted from the obtained sequence and the addition operation is performed modulo 2 XOR (305). The input data for the addition operation modulo 2, in addition to the previously obtained sequence, is the resulting cipher text (304). The result of the operation (211) is the navigation coordinates that can be used by the receiver further to the destination.

FIG. 9 shows a generalized block diagram of the system implementing the specified method of data protection transmitted in the NMEA standard. To implement the algorithms described above, encryption/decryption units (401, 402) are integrated in the time receiver or navigation device (101), as well as in the control device (102). These modules are designed to implement block encryption algorithm AES-128 (CFB mode).

1. A system for protecting transmitted data in a vehicle control system, comprising:
a vehicle or navigation device and a control module communicatively connected to the navigation device according to NMEA standard; and
an encryption/decryption unit integrated in the navigation device and in the control module including an AES128 block encryption algorithm in a Cipher Feedback mode (CFB mode), the unit including instructions to encrypt/decrypt data transmitted between the navigation device and the control module.

2. The system of claim 1,
wherein the data includes a set of geographical coordinates of the navigation device for sending to the control module,
wherein the encryption/decryption unit in the navigation device includes instructions to encrypt a set of geographical coordinates using the AES128 block encryption algorithm in the CFB mode, and
wherein the encryption/decryption unit in the control module includes instructions to decrypt the encrypted set of geographical coordinates received from the navigation device for determining a location thereof; and
wherein the system applies to the geographical coordinates and to all NMEA protocol data traffic.

3. The system of claim 2, wherein the set of geographical coordinates of the navigation device is sent with one of the following message identifiers: Bearing & Distance to Waypoint (BEC), Bearing and Distance to Waypoint (BWR), Global Positioning System Fix Data (GGA), Geographic Position (GLL), Recommended Minimum Navigation Information (RMA), Recommended Minimum Navigation Information (RMB), Recommended Minimum Navigation Information (RMC), Waypoint Location (WPL), $PGRMFPosition Fix Sentence, and $PGRMISensor Initialisation Information.

4. The system of claim 2, wherein the set of geographical coordinates of the navigation device includes a latitude parameter and a longitude parameter, wherein the latitude and the longitude parameters are in the following format, respectively: BBBB.BBBB,a (BB—degrees; BB.BBBB—whole and fractional minutes; a—North/South) and LLLLL.LLLL,a (LLL—degrees; LL.LLLL—whole and fractional minutes; a—East/West).

5. The system of claim 2, wherein the encryption/decryption unit in the navigation device further includes instructions to encrypt a first initialization vector using a first encryption key and to determine a ciphertext for sending to the control module, the ciphertext based on the encrypted first initialization vector and the set of geographical coordinates of the navigation device.

6. The system of claim 5, wherein the encryption/decryption unit in the control module further includes instructions to receive the ciphertext, to encrypt a second initialization vector using a second encryption key, and to determine the location of the navigation device based on the encrypted second initialization vector and the ciphertext.

7. The system of claim 6, wherein the first initialization vector and the second initialization vector are the same.

8. The system of claim 7, wherein the first initialization vector and the second initialization vector are entered by a user in manual or automatic modes.

9. The system of claim 6, wherein the first encryption key and the second encryption key are the same; and wherein the first encryption key and the second encryption key can be entered in manual and automatical mode.

10. A method for protecting data in a vehicle control system, comprising:
determining, in a vehicle or navigation device, data for sending to one or more control modules, wherein the data includes a set of geographical coordinates of the navigation device;
encrypting the data using an AES128 block encryption algorithm in a Cipher Feedback mode (CFB mode);
sending the encrypted data according to NMEA standard to the one or more control modules for decryption by the one or more control modules using the AES128 block encryption algorithm in the CFB mode; and
wherein the method applies to the geographical coordinates and to all NMEA protocol data traffic.

11. The method of claim 10,
wherein the determining the data includes determining a set of geographical coordinates of the navigation device, and
wherein the set of geographical coordinates includes a latitude parameter and a longitude parameter set in the following format, respectively: BBBB.BBBB,a (BB—degrees; BB.BBBB—whole and fractional minutes; a—North/South) and LLLLL.LLLL,a (LLL—degrees; LL.LLLL—whole and fractional minutes; a—East/West).

12. The method of claim 11, wherein the sending the encrypted information data includes sending the set of geographical coordinates with one of the following message identifiers: Bearing & Distance to Waypoint (BEC), Bearing and Distance to Waypoint (BWR), Global Positioning System Fix Data (GGA), Geographic Position (GLL), Recommended Minimum Navigation Information (RMA), Recommended Minimum Navigation Information (RMB), Recommended Minimum Navigation Information (RMC), Waypoint Location (WPL), $PGRMFPosition Fix Sentence, and $PGRMISensor Initialisation Information.

13. The method of claim 10, wherein the encrypting the data includes encrypting a first initialization vector using a first encryption key and determining a ciphertext based on the encrypted first initialization vector and the data for sending to the one or more control modules, and wherein the sending the encrypted data includes sending the determined ciphertext to the one or more control modules for decryption.

14. The method of claim 13, further comprising following receipt of the ciphertext, in the one or more control modules, encrypting a second initialization vector using a second encryption key and determining the data from the navigation device based on the encrypted second initialization vector and the ciphertext.

15. The method of claim 14, wherein the first initialization vector and the second initialization vector are the same.

16. The method of claim 15, wherein the first initialization vector and the second initialization vector are entered by a user in manual or automatic modes.

17. The method of claim 14, wherein the first encryption key and the second encryption key are the same; and wherein the first encryption key and the second encryption key can be entered in manual and automatical mode.

18. The method of claim 13, wherein the determining the ciphertext includes performing an XOR-sum between a predetermined number of bits of the encrypted first initialization vector and the data for sending to the one or more control modules.

19. The method of claim 14, wherein the determining the data includes performing an XOR-sum between a predetermined number of bits of the encrypted second initialization vector and the ciphertext.

20. The method of claim 10, wherein the navigation device and the one or more control modules each include an encryption/decryption unit including instructions for performing the AES128 block encryption algorithm in the CFB mode.
